(19) United States
(12) Patent Application Publication
(10) Pub. No.: US 2009/0289164 A1
(43) Pub. Date: Nov. 26, 2009

(54) HANGER

(76) Inventor: FRANK GUTIERREZ, Phoenix, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/536,344

(22) Filed: Aug. 5, 2009

Related U.S. Application Data
(63) Continuation of application No. 11/561,389, filed on Nov. 18, 2006, now abandoned.

(51) Int. Cl. F16M 13/00

(52) U.S. Cl. 248/342

(57) ABSTRACT

A hanger includes a fixture adapted to be secured to an upright support at an elevated location. A runner and a slot are formed in the fixture. The runner extends into the fixture and communicates with the slot. The runner is to initially receive an end of an object to be hung and guide the end of the object to be hung to the slot, and the slot is to receive the end of the object to be hung from the runner and frictionally secure the end of the object to be hung from the runner.

### CROSS-REFERENCE TO RELATED APPLICATION

This application claims the benefit of U.S. patent application Ser. No. 11/561,389, filed Nov. 18, 2006.

### FIELD OF THE INVENTION

The present invention relates to hangers and, more particularly, to hangers used to suspend objects from elevated locations for temporary or long term storage.

### BACKGROUND OF THE INVENTION

Having inadequate kitchen storage is a common home problem and probably the most common storage problem. Even in large kitchens, finding adequate space to efficiently accommodate kitchen appliances and countertop implements is an ever present problem. This problem is exacerbated by the additional clutter of onions, tomatoes, loaves of bread, and other perishable food items that typically are not stored in the refrigerator or the pantry. Although such food items are often stored directly on the countertop or in bowls or other specialized countertop containers, such storage solutions can actually accelerate food spoilage and again contribute to countertop clutter, thereby necessitating a storage solution that eliminates countertop clutter and also provides a way to store perishable food, such as loaves of bread and other forms of perishable food, in such a way that prolongs the freshness of the perishable food.

### SUMMARY OF THE INVENTION

According to the principle of the invention, a hanger includes a fixture having opposed, substantially parallel inner and outer ends, opposed, substantially parallel first and second sides, and an opposed substantially parallel upper and lower surfaces. The inner end of the fixture is adapted to be secured to an upright support, such as a wall, at an elevated location. A runner and a slot are formed in the fixture. The runner and the slot extend through the fixture from the upper surface to the lower surface. The slot is narrowed with respect to the runner, and the runner is a broad, generally wedge-shaped cutout formed in the fixture.

In one embodiment, the runner formed by the generally wedge-shaped cutout is formed in the first side of the fixture and communicates with the slot, which slot is located at a generally intermediate position between the opposed inner and outer ends of the fixture. The runner is to initially receive an end of an object to be hung from the first side of the fixture and guide the end of the object to be hung to the slot, and the slot is to receive the end of the object to be hung from the runner and frictionally secure the end of the object to be hung. The slot in the present embodiment is substantially parallel with respect to the inner and outer ends of the fixture, and is located between the first and second sides of the fixture.

In another embodiment, the runner formed by the generally wedge-shaped cutout is formed in the outer end of the fixture and communicates with the slot, which slot is located at a generally intermediate position between the opposed inner and outer ends of the fixture. The runner is to initially receive an end of an object to be hung from the outer end of the fixture and guide the end of the object to be hung to the slot, and the slot is to receive the end of the object to be hung from the runner and frictionally secure the end of the object to be hung. The slot in the present embodiment is substantially parallel with respect to the first and second sides of the fixture, and is located between the first and second sides of the fixture.

### BRIEF DESCRIPTION OF THE DRAWINGS

Referring to the drawings:

FIG. 1 is a perspective view of a hanger constructed and arranged in accordance with the principle of the invention and shown in use suspending a bag containing bread;

FIG. 2 is an enlarged perspective view of the hanger of FIG. 1;

FIG. 3 is a top plan view of the hanger of FIG. 1;

FIG. 4 is a rear perspective view of the hanger of FIG. 1;

FIG. 5 is an enlarged perspective view of the hanger of FIG. 1 shown as it would appear in use suspending the bag containing bread;

FIG. 6 is a section view taken along line 6-6 of FIG. 2 illustrating a bag positioned with respect to a groove formed in the hanger; and

FIG. 7 is a side elevation view of the hanger of FIG. 1 shown as it would appear in use suspending the bag of bread.

### DETAILED DESCRIPTION

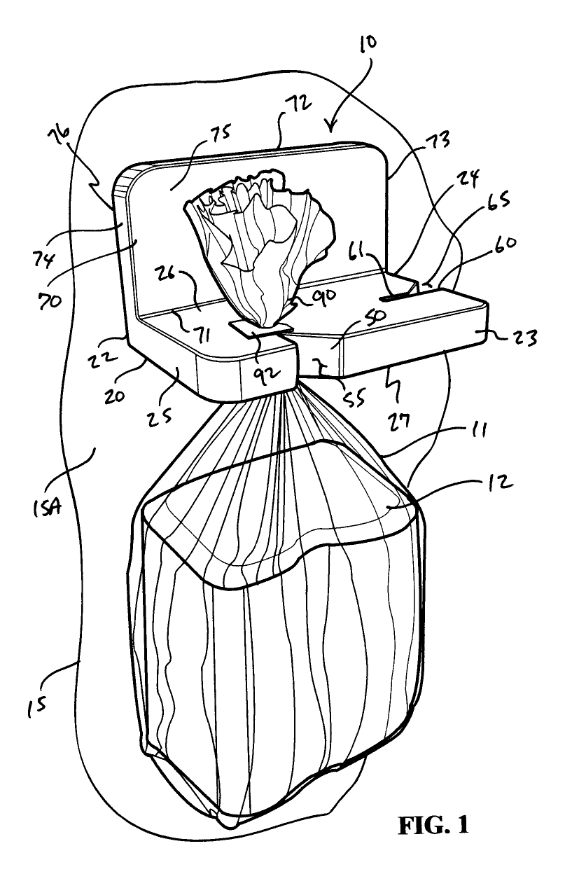

Turning now to the drawings, in which like reference characters indicate corresponding elements throughout the several views, attention is first directed to FIG. 1 in which there is seen a perspective view of a hanger 10 constructed and arranged in accordance with the principle of the invention used to receive and suspend items therefrom for storage, such as bag 11 containing bread denoted at 12. Hanger 10 is formed of wood, plastic, metal, or other substantially rigid material or combination of materials, and is preferably integrally formed, but may be formed of a plurality of parts attached by way of welding, glue, or mechanical fasteners, such as nails, screws, or the like.

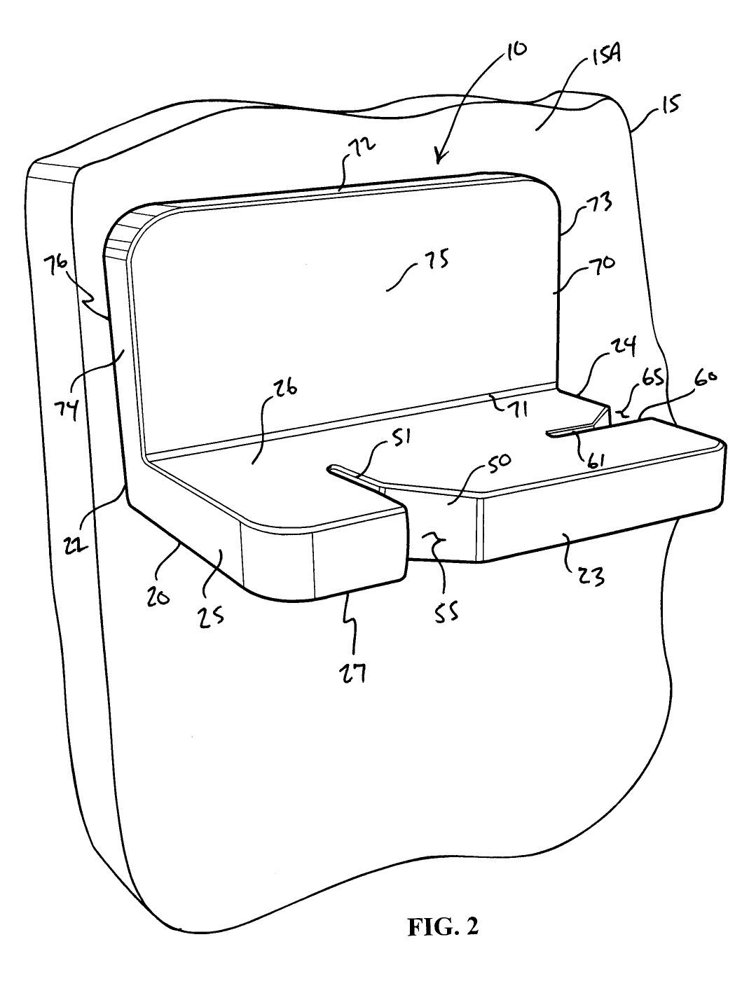

Looking FIG. 2, hanger 10 consists of a fixture 20, which has opposed inner and outer ends 22 and 23, opposed sides 24 and 25 extending therebetween, and opposed upper and lower surfaces 26 and 27. In the present embodiment, fixture 20 is formed substantially in the shape of a rectangular block that is broad and flat, in which inner end 22 is substantially parallel with respect to outer end 23, side 24 is substantially parallel with respect to side 25, and upper surface 26 is substantially parallel with respect to lower surface 27.

Referencing FIG. 2, a runners 50 and 60 and slots 51 and 61 are formed in fixture 20. Runner 50 relates to slot 51, and runner 60 relates to slot 61. Runner 50 and slot 51 are formed between sides 24 and 25 of fixture 20 and extend through fixture 20 from upper surface 26 to lower surface 27, and runner 60 and slot 61 are formed between inner and outer ends 22 and 23 of fixture 20 and extend through fixture 20 from upper surface 26 to lower surface 27. In the present example, runner 50 and slot 51 associated with runner 50 are located proximate to side 25 of fixture 20, and this is illustrated merely by way of example.

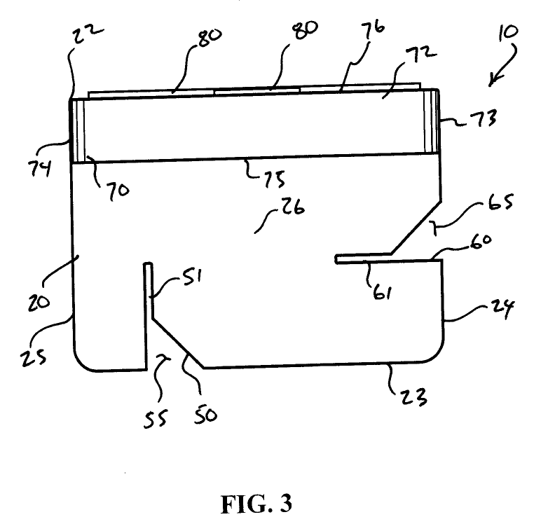

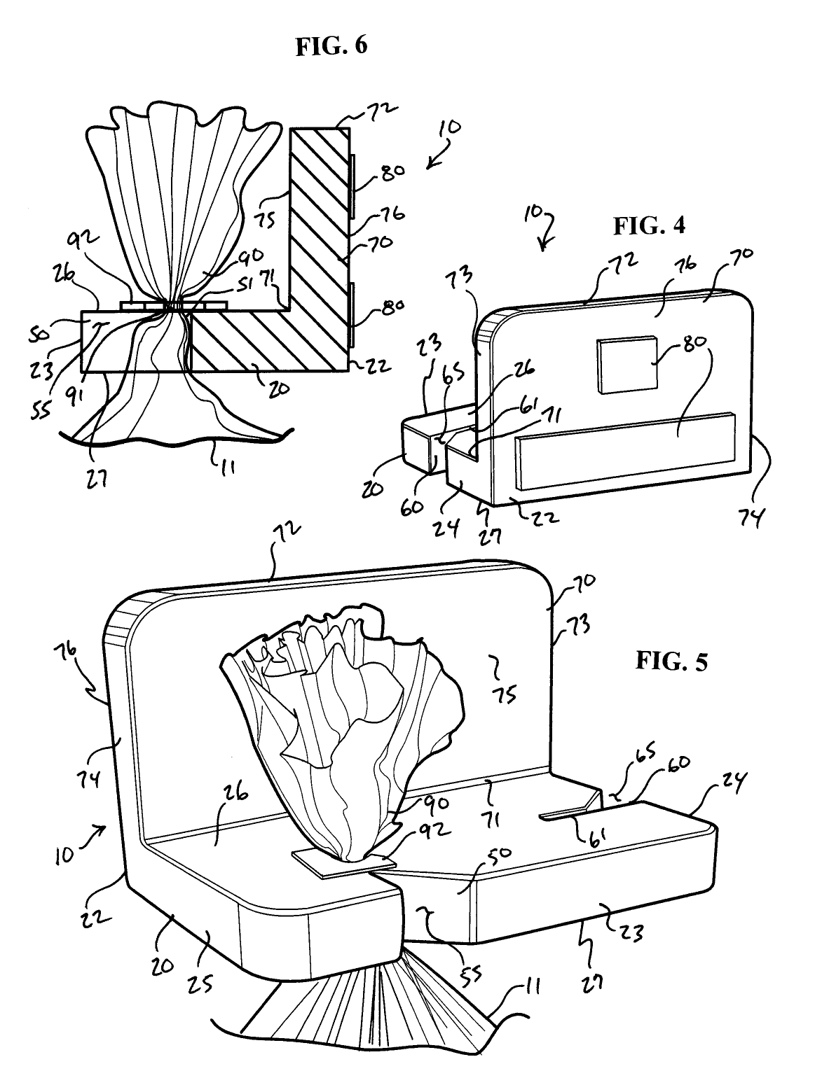

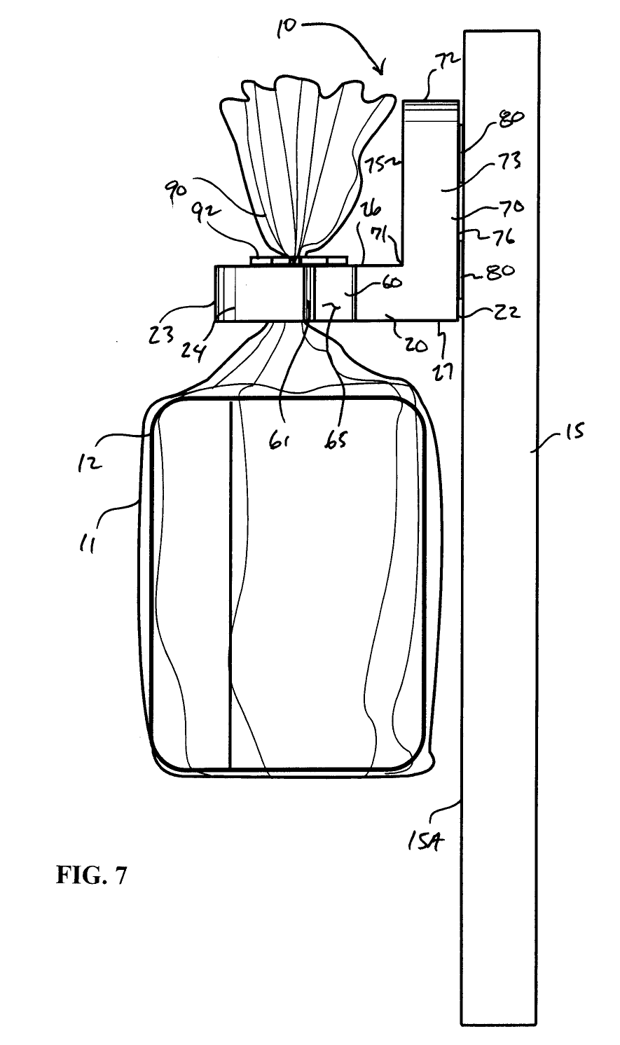

Looking to FIG. 3, slot 51 is elongate and is narrowed with respect to runner 50, which is a broad, generally wedge-shaped cutout 55 formed in fixture 20. In the present embodiment, wedge-shaped cutout 55 forming runner 50 is formed in, and extends into, outer end 23 of fixture 20, and leads to and communicates with slot 51. Slot 51 is located at a generally intermediate position between inner and outer ends 22 and 23 of fixture 20, and is substantially parallel with respect to sides 24 and 25 of fixture 20. Slot 61 is elongate and is narrowed with respect to runner 60, which is a broad, generally wedge-shaped cutout 65 formed in fixture 20. In the present embodiment, wedge-shaped cutout 65 forming runner 60 is formed in, and extends into, side 24 of fixture 20, and leads to and communicates with slot 61. Slot 61 is located at a generally intermediate position between inner and outer ends 22 and 23 of fixture 20, and is substantially parallel with respect to inner and outer ends 22 and 23 of fixture 20.

Inner end 22 of fixture 20 is configured or otherwise adapted to be secured to an upright support, such as wall 15 denoted in FIGS. 1 and 2, at an elevated location. This configuration is provided by a back 70 formed in inner end 22 of fixture 20. Back 70 projects upright with respect to upper surface 26. Back 70 is broad and flat and has a lower end 71 affixed to inner end 22 of fixture 20, and projects upright therefrom to an opposed upper end 72. Back 70 has opposed sides 73 and 74 that extend between lower end 71 and upper end 72 of back 70, a front surface 75 facing upper surface 26 and outer end 23 of fixture 20, and an opposed rear surface 76 illustrated in FIG. 4 that faces away from upper surface 26 and outer end 23 of fixture 20 denoted in FIGS. 1 and 2. In the present embodiment, back 70 is substantially rectangular in shape and is broad and flat, in which lower end 71 is substantially parallel with respect to upper end 72, side 73 is substantially parallel with respect to side 74, and front surface 75 is substantially parallel with respect to rear surface 76. Sides 73 and 75 of back 70 are contiguous with respect to sides 24 and 25 of fixture 20, front surface 75 of back 70 is contiguous with respect to upper surface 26 of fixture 20. Back 70 is substantially perpendicular with respect to fixture 20, such that front surface 75 is substantially perpendicular with respect to upper surface 26 of fixture 20.

Looking FIG. 4, pieces 80 of conventional and readily available double sided tape are applied to rear surface 76 of back 70, which are applied against surface 15A of wall 15 as shown in FIG. 7 to adhesively secure hanger 10, and thus fixture 20, to wall 15 at an elevated location. In accordance with the principle of the invention, back 70 positioned upright with respect to surface 15A of wall 15 and is secured to surface 15A by then applying pieces 80 of double sided tape against surface 15A of wall 15. Properly secured to surface 15A of wall 15, at an elevated location, back 70 extends substantially vertically upright from lower end 71 to upper end 72, and fixture 20 extends outwardly from back 70 away from surface 15A of wall 15 from inner end 22 of fixture 20 to outer end 23 of fixture 20, and fixture 20 is substantially horizontal, and is substantially perpendicular with respect to surface 15A of wall 15. In the present embodiment, two pieces 80 of double sided tape are used to adhesively secure back 70 to surface 15A of wall 15 to thereby secure inner end 22 of fixture 22 with respect to surface 15A of wall 15. Although two pieces 80 of double sided tape are used in the present embodiment, less or more can be used as may be desired. Furthermore, screws, nails, conventional hangers, or the like, may be formed between back 70 and surface 15A of wall 15 to secure inner end 22 of fixture 20 with respect to surface 15A of wall 15. FIGS. 1, 2, and 7 illustrate the installation of hanger 10 with respect to surface 15A of wall 15, in which hanger 10 is disposed at an elevated location. So secured with respect to surface 15A of wall 15, hanger 10 is prepared and ready to take on items to be suspended, such as bags containing bread or other selected material.

Referencing FIG. 2, runner 50 is to initially receive an end of an object to be hung from outer end 23 of fixture 20 and guide the end of the object to be hung to slot 51, and slot 51 is to receive the end of the object to be hung from runner 50 and frictionally secure the end of the object to be hung. Runner 60 is to initially receive an end of an object to be hung from side 24 of fixture 20 and guide the end of the object to be hung to slot 61, and slot 61 is to receive the end of the object to be hung from runner 60 and frictionally secure the end of the object to be hung. Objects that may be hung from hanger 10 typically include bags of material, such as bags of edible material or bags of inedible material.

As a matter of example, in FIGS. 1 and 7 there is illustrated bag 11 containing a loaf of bread 12. Bag 11 is made of plastic or other durable, flexible material, and has an openable end 90 that is closed with a crimp 91 formed in openable end 90 of bag 11 secured with a tie or clip 92. To suspend bag 11, containing loaf of bread 12, from fixture 20, bag 11 is taken up and openable end 90 of bag 11 proximate to crimp 91 and clip 92 is initially applied to runner 50, and then is forcibly applied into slot 51 from runner 50 frictionally securing that portion of bag 11 extending in slot 51 in and by slot 51 suspending bag 11 containing loaf of bread 12 from fixture 20 of hanger 10. In the present example, openable end 90 of bag 11 is inserted into or otherwise positioned with respect to slot 51 to locate clip 92 atop upper surface 26 of fixture 20. Runner 50 formed by cutout 55 functions to initially receive openable end 90 of bag 11 and guide openable end 90 of bag 11 to slot 51 as openable end 90 of bag 11 is maneuvered toward slot 51 from runner 50. FIGS. 1 and 7 illustrate bag 11 so installed with respect to slot 51 and suspended from fixture 20, in which bag 11 is suspended and held away from surface 15A of wall 15 by fixture 20 of hanger 10. With bag 11 containing loaf of bread 12 so suspended from fixture 20 and held away from surface 15A of wall 15, air is free to flow around bag 11 encasing loaf of bread 12 to help maintain loaf of bread 12 at a uniform temperature to prolong the freshness of loaf of bread 12 preventing loaf of bread 12 from becoming stale, developing mold and becoming inedible or otherwise spoiling, which happens with bagged bread stored directly against counters, bread containers, or other support or storage surfaces. To detach bag 11 from slot 51, one need only take up bag 11, such as by hand, and forcibly pull bag 11 from slot 51 and away from fixture 20 of hanger 10. In lieu of loaf of bread 12, bag 11 can contain bagels, hot dog buns, hamburger buns, or other food material, whether cookies, candy, fruit, etc.

Runner 50 and slot 51 are formed with respect to outer end 23 of fixture 20 as illustrated in the various figures, and together are useful in suspending objects for storage with respect to outer end 23 of fixture 20 of hanger 10. The installation and removal of an object to be hung, such as bag 11 containing loaf of bread 12, with respect to runner 60 and slot 61 is identical to that of runner 50 and slot 51. Runner 60 and slot 61 are formed with respect to side 24 of fixture 20 as illustrated in the various figures, and together are useful in suspending objects for storage with respect to side 24 of fixture 20.

In the present example, hanger 10 is secured to surface 15A of wall 15, at an elevated location, such that back 70 extends substantially vertically upright from lower end 71 to upper end 72, and fixture 20 extends outwardly from back 70 away from surface 15A of wall 15 from inner end 22 of fixture 20 to outer end 23 of fixture 20, and fixture 20 is substantially horizontal, and is substantially perpendicular with respect to surface 15A of wall 15. Hanger works equally well flipped around. In this installation, hanger 10 is secured to surface 15A of wall 15, at an elevated location, such that back 70 extends substantially vertically downward from end 71 to end 72, and fixture 20 extends outwardly from back 70 away from surface 15A of wall 15 from inner end 22 of fixture 20 to outer end 23 of fixture 20, and fixture 20 is substantially horizontal, and is substantially perpendicular with respect to surface 15A of wall 15. Use of hanger 10 in this installation is the same as before.

The invention has been described above with reference to a preferred embodiment. However, those skilled in the art will recognize that changes and modifications may be made to the embodiment without departing from the nature and scope of the invention. Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A hanger, comprising:
a fixture having opposed, substantially parallel inner and outer ends, opposed, substantially parallel first and second sides, and an opposed substantially parallel upper and lower surfaces;
the inner end of the fixture adapted to be secured to an upright support at an elevated location;
a runner and a slot formed in the fixture;
the runner and the slot extend through the fixture from the upper surface to the lower surface;
the runner extends into the fixture from the first side of the fixture and communicates with the slot located at a generally intermediate position between the opposed inner and outer ends of the fixture; and
the runner to initially receive an end of an object to be hung from the first side of the fixture and guide the end of the object to be hung to the slot, and the slot to receive the end of the object to be hung from the runner and frictionally secure the end of the object to be hung.

2. The hanger according to claim 1, wherein the slot is narrowed with respect to the runner.

3. The hanger according to claim 2, wherein the slot is substantially parallel with respect to the inner and outer ends of the fixture.

4. The hanger according to claim 3, wherein the runner is comprised of a broad, generally wedge-shaped cutout.

5. A hanger, comprising:
a fixture having opposed, substantially parallel inner and outer ends, opposed, substantially parallel first and second sides, and an opposed substantially parallel upper and lower surfaces;
the inner end of the fixture adapted to be secured to an upright support at an elevated location;
a runner and a slot formed in the fixture;
the runner and the slot extend through the fixture from the upper surface to the lower surface;
the runner extends into the fixture from the outer end of the fixture and communicates with the slot located at a generally intermediate position between the opposed inner and outer ends of the fixture; and
the runner to initially receive an end of an object to be hung from the outer end of the fixture and guide the end of the object to be hung to the slot, and the slot to receive the end of the object to be hung from the runner and frictionally secure the end of the object to be hung.

6. The hanger according to claim 5, wherein the slot is narrowed with respect to the runner.

7. The hanger according to claim 6, wherein the slot is substantially parallel with respect to the first and second sides of the fixture.

8. The hanger according to claim 7, wherein the runner is comprised of a broad, generally wedge-shaped cutout.
